(19) United States
(12) Patent Application Publication
(10) Pub. No.: US 2024/0185190 A1
(43) Pub. Date: Jun. 6, 2024

(54) Digital Format Custodial Services

(71) Applicant: Bank Of America Corporation, Charlotte, NC (US)

(72) Inventors: Prabhat Ranjan, Plano, TX (US); Willard Waldron, Charlotte, NC (US); Jeff Lojko, Miami, FL (US)

(21) Appl. No.: 18/060,906

(22) Filed: Dec. 1, 2022

(51) Int. Cl. G06Q 20/02; G06Q 20/06

(52) U.S. Cl. CPC G06Q 20/027; G06Q 20/0658; G06Q 2220/00

(57) ABSTRACT

Systems, processes, and methods for the conversion of an individual's conventional bank held assets to a digital asset integrated with a blockchain system are disclosed herein.

### FIELD OF USE

Aspects of the disclosure relate to systems, processes, and methods for the merging of decentralized finance systems with traditional banking services in accordance with Know Your Customer guidelines for the prevention of fraud, prevention of monetary obfuscation, and prevention of the unauthorized access to online banking database systems, applications, and related customer data and assets, including the manner of identifying customers, authorizing transactions, and verifying the entity, process, or mechanism requesting access to the banking resource and application. More particularly, aspects of the disclosure relate to systems, processes, and methods for the conversion of conventional assets to digital assets integrated with a blockchain system.

### BACKGROUND

Decentralized finance (DeFi) is an emerging financial technology that challenges the current centralized banking system. DeFi technologies eliminate payments that banks and other financial companies charge for using their services. Accordingly, DeFi technologies encourage the use of independent peer-to-peer transactions. DeFi systems, however, lack fluidity, are at times cumbersome, and lack a general trust required to conduct traditional banking clearing house transactions. Further, DeFi systems generally fail to comply with Know Your Customer (KYC) guidelines in financial services requiring that banking professionals attempt to verify the identity, suitability, and risks involved with maintaining a business relationship with customers making compliance with the broader scope of a bank's monetary obfuscation policy difficult. It would be advantageous to provide a secured, trustworthy DeFi payment platform for a traditional banking user base integratable across traditional banking clearing house functions.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

In one general aspect of this disclosure, a system of one or more computer executable software and data, computer machines and components thereof, networks, and/or network equipment can be configured to perform particular operations or actions individually, collectively, or in a distributed manner to cause the system or components thereof to convert conventional assets to digital assets integrated with a blockchain system.

Systems, processes, and methods disclosed herein for dynamically converting a user conventional net asset value (i.e., net worth) to a digital asset for use in a financial transaction may include a computer machine with a processor that executes computer-executable instructions stored on a computer-readable medium, a banking transaction tool, and a digital asset conversion platform coupled together over a communication network. The process for dynamically converting the user conventional net asset value to the digital asset may include the steps of receiving a user request for access to the digital asset conversion platform with the banking transaction tool, authenticating the user credentials, receiving a financial transaction request from the banking transaction tool, using the digital asset conversion platform to generate a digital asset based upon the user's conventional net asset value. In some examples, the system, processes, and methods disclosed herein may further include the steps of receiving a transaction value for the financial transaction request, transmitting the transaction value in the form of the digital asset to a third party or institution related to the financial transaction, and receiving a confirmation that the third party received the transaction value completing the financial transaction request. In other examples, the system, processes, and methods disclosed herein may further include the steps of calculating an updated user conventional net asset value using the digital asset conversion platform, storing a record of the financial transaction, generating a blockchain ledger of the financial transaction, and generating a transaction tax summary with the digital asset conversion platform.

In some examples disclosed herein the digital asset may be in the form of Bitcoin or other cryptocurrency. In one example disclosed herein, the digital asset may be a non-fungible token (NFT). In other examples disclosed herein, the banking transaction tool may be accessible via a mobile phone. In still other examples disclosed herein, the financial transaction may be a credit card transaction, a debit card transaction, a mortgage related transaction, a crypto currency transaction, or a clearing house transaction. In yet another example disclosed herein, the transaction tax summary may be stored in a blockchain and/or the record of the financial transaction and the transaction tax summary may be stored on a digital asset transaction database. In some examples disclosed herein, the user net asset value may be determined from a native fiat currency, a retirement account, real estate, a mortgage, a deed, a commodity, a mutual fund, an equity, a crypto currency, intellectual property, a non-fungible token (NFT), or combinations thereof. In certain examples disclosed herein, the digital asset may be used in a liquidity pool for use in bank and lending services.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates a computing operating environment in which one or more aspects described herein may be implemented;

FIG. 2 illustrates an example computer machine in accordance with one or more aspects described herein;

FIG. 3 depicts a flow chart for a transaction between two entities in which a user conventional net asset value may be dynamically converted to a digital asset for use in the transaction according to one or more aspects described herein;

FIG. 4 depicts an additional flow chart for the process depicted in FIG. 3 for a transaction between two entities according to one or more aspects described herein;

FIG. 5 illustrates a general centralized blockchain system environment architecture, in accordance with one or more aspects described herein; and

FIG. 6 illustrates a general decentralized blockchain system environment architecture, in accordance with one or more aspects described herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein relate to integrated banking services to assist people with converting conventional assets to digital assets. A bank member will have a validated relationship of trust with the banking institution meeting regulatory requirements. As such, additional financial services may be integrated and offered to the user. For example, digital currency transfers may be facilitated (e.g., conversion of conventional savings or checking account funds to digital cryptocurrencies) at near real-time in the background to simplify digital asset transactions for the bank member/customer, using existing banking applications. After completion to the financial transaction, a financial and tax record may be generated and tracked using a blockchain system. As such, the bank member may have access to a consolidated tax summary or report to simplify the resolution of personal Federal and state tax obligations. Alternatively, aspects disclosed herein include systems, processes, and methods for the integration and tracking of other assets and related documents using a blockchain such as mortgages and deeds. Such systems, processes, and methods would be advantageous in regions that historically encounter difficulties related to custodial services (e.g., a local government may control particular documents and may dispute assertions of ownership). As disclosed herein, custodial documents may be securely stored on a blockchain and maintained by the related financial institution.

Additional aspects of the disclosure related to a digital payment platform that may be integratable with existing online baking applications. For example, the platform may integrate a user's cryptocurrency wallet with the existing online banking application and maintain a digital asset repository or related database to maintain a record of cryptocurrency or other digital transactions independent of or in combination with other conventional transactions and related databases to provide a near real-time aggregation and integration of both online conventional banking and cryptocurrency (i.e., digital asset) transactions. In essence, the systems, processes, and methods disclosed herein leverage existing customer relationships with a bank to overcome the clumsiness and difficulties encountered with traditional cryptocurrency transactions. The digital asset conversion platform disclosed herein facilitates the conversion of conventional assets to digital assets permitting the bank to function as a digital clearing house.

In some embodiments disclosed herein, the digital asset conversion platform may be accessed by a user interface to a traditional online banking tool. The platform may be configured to link and integrate user cryptocurrency account data and holdings and conventional bank account and related holdings for use across various financial transactions and functions such as deposits, withdrawals, savings, credit and debit card purchases and cash withdrawals, remittances, other banking custodial services, insurance related transactions, liquidity pool participation in which traditional deposits are converted to digital assets for yield farming, token trading, etc. In some examples, the integrated digital assets or currency may be used by the platform as part of a calculated net worth or net asset value for lending services or other financial transaction. In another embodiment disclosed herein, the digital asset conversion platform may be configured to facilitate a bank remittance from the user account to another in the form of a digital cryptocurrency to native currency in near real-time Remittance, Crypto Debit card which behind the scenes converts Bitcoin to native currency in near real time and facilitating the settlement at both the bank and the other account.

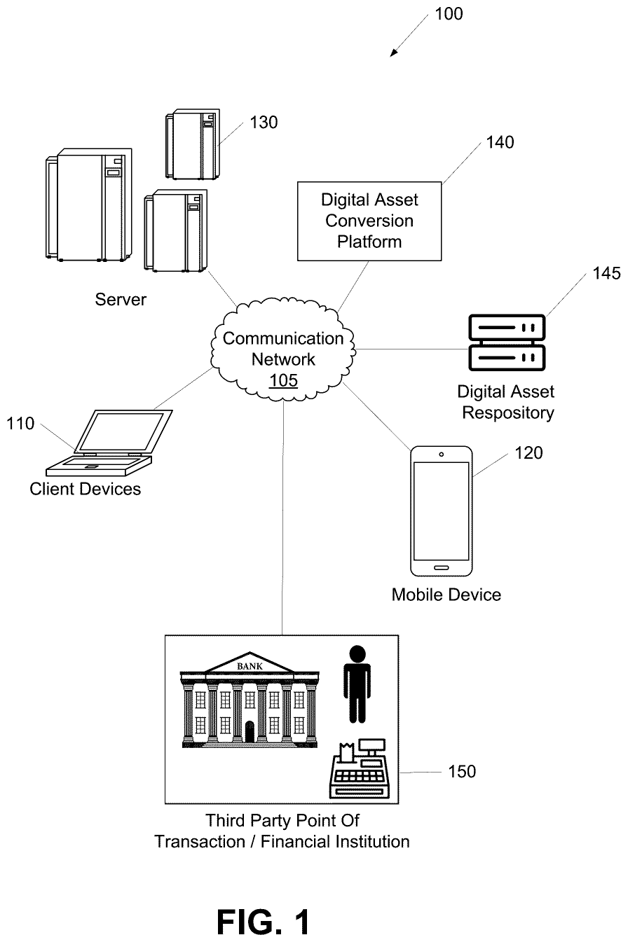

FIG. 1 illustrates an illustrative computing environment 100 in accordance with an embodiment of the disclosure. Operating environment 100 may include at least one client device or computer machine 110, may include a mobile device 120, may include at least server system 130, may include digital asset conversion platform 140, digital asset repository 145, and/or a third party point of transaction in communication via communication network 105. Client device 110 and mobile device 120 may provide user access to digital asset conversion platform 140 as described herein. Server system 130 may receive input to process user financial transaction requests and to authenticate user profiles and credentials as described herein. Network 105 may comprise public networks and/or private networks. Network 105 may include a local area network (LAN), a wide area network (WAN), a wireless telecommunications network, and/or any other communication network or combinations thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computer machines described herein may be configured to communicate using any of these network protocols or technologies.

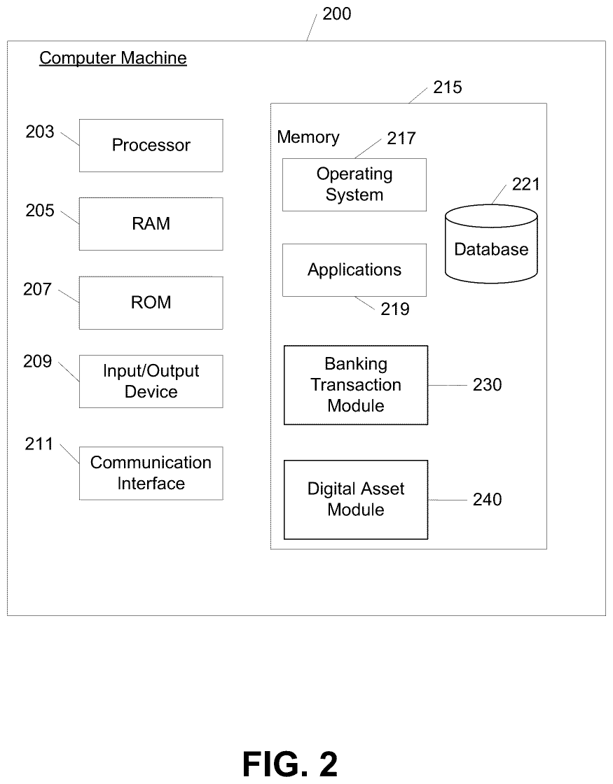

As used throughout this disclosure, computer-executable “software and data” can include one or more: algorithms, applications, databases, datasets (e.g., historical datasets), drivers, data structures, engines, firmware, graphical user interfaces, instructions, machine learning (i.e., supervised, semi-supervised, reinforcement, and unsupervised), middleware, modules (i.e., digital asset module, banking transaction module), objects, operating systems, platforms, processes, programs, scripts, tools, and utilities. The computer-executable software and data may be stored in tangible, non-volatile, computer-readable memory (locally or in network-attached storage) and can operate autonomously, on-demand, on a schedule, and/or spontaneously. “Computer machines” can include one or more: general-purpose or special-purpose network-accessible client device, personal computers, desktop computers, laptop or notebook computers, distributed systems, workstations, portable electronic devices, printers, scanners, facsimile machines, multifunction devices, and/or servers having one or more microprocessors for executing or accessing the computer-executable software and data. Computer machines also includes all hardware and components typically contained therein. The “servers” can be virtual or physical, on-premise or remote, and can include one or more: application servers, cybersecurity servers, test servers, and/or web servers for executing, accessing, and/or storing the computer-executable software and data. Computer “communication networks” or “networks” may include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of any of the same. Networks also include associated “network equipment” such as access points, ethernet adaptors (physical and wireless), firewalls, hubs, modems, routers, and/or switches located inside the network and/or on its periphery, as well as software executing on any of the foregoing. Any of the devices and systems described herein may be implemented, in whole or in part, using one or more computer machines or computing machines described with respect to FIG. 2.

Some or all of the data described herein may be stored using any of a variety of data storage mechanisms, such as databases or other repository. These databases may include, but are not limited to relational databases, hierarchical databases, distributed databases, in-memory databases, flat file databases, XML databases, NoSQL databases, graph databases, and/or combinations thereof. The data transferred to and from various computer machines in operating environment 100 may include secure and sensitive data, such as confidential documents, customer personally identifiable information, and account data. It may be desirable to protect transmissions of such data using secure network protocols and encryption and/or to protect the integrity of the data when stored on the various computer machines. For example, a file-based integration scheme or a service-based integration scheme may be utilized for transmitting data between the various computer machines. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computer machines. Web services may be accessed by authorized external devices and users to support input, extraction, and manipulation of data between the various computer machines in operating environment 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computer machines. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in the operating environment 100 in front of one or more computer machines such that any external devices may communicate directly with the specialized hardware.

Turning now to FIG. 2, computer machine 200 in accordance with an embodiment of the disclosure is illustrated. Computer machine 200 may include a processor 203 for controlling overall operation of the computer machine 200 and its associated components, including RAM 205, ROM 207, input/output device 209, communication interface 211, and/or memory 215. A data bus may interconnect processor(s) 203, RAM 205, ROM 207, memory 215, I/O device 209, and/or communication interface 211. In some embodiments, computer machine 200 may represent, be incorporated in, and/or include various devices such as a desktop computer, a computer server, a mobile device, such as a laptop computer, a tablet computer, a smart phone, any other types of mobile computer machines, and the like, and/or any other type of data processing device.

Input/output (I/O) device 209 may include a microphone, keypad, touch screen, and/or stylus through which a user of the computer machine 200 may provide input, and may also include one or more of a speaker for providing audio output and a video display device for providing textual, audiovisual, and/or graphical output. Communication interface 211 may include one or more transceivers, digital signal processors, and/or additional circuitry and software for communicating via any network, wired or wireless, using any protocol as described herein. Software may be stored within memory 215 to provide instructions to processor 203 allowing computer machine 200 to perform various actions. For example, memory 215 may store software used by the computer machine 200, such as an operating system 217, application programs or modules 219, and/or an associated internal database 221. In some examples, memory 215 may include banking transaction module 230, and/or digital asset module 240. The various hardware memory units in memory 215 may include volatile and nonvolatile, removable and non-removable media implemented in any method or technology for storage of information such as computer-readable instructions, data structures, program modules, or other data. Memory 215 may include one or more physical persistent memory devices and/or one or more non-persistent memory devices. Memory 215 may include, but is not limited to, random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Processor 203 may include a single central processing unit (CPU), which may be a single-core or multi-core processor, or may include multiple CPUs. Processor(s) 203 and associated components may allow the computer machine 200 to execute a series of computer-readable instructions to perform some or all of the processes described herein. Although not shown in FIG. 2, various elements within memory 215 or other components in computer machine 200, may include one or more caches, for example, CPU caches used by the processor 203, page caches used by the operating system 217, disk caches of a hard drive, and/or database caches used to cache content from database 221. For embodiments including a CPU cache, the CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing machine 200 are described separately, functionality of the various components may be combined and/or performed by a single component and/or multiple computer machines in communication without departing from the disclosure.

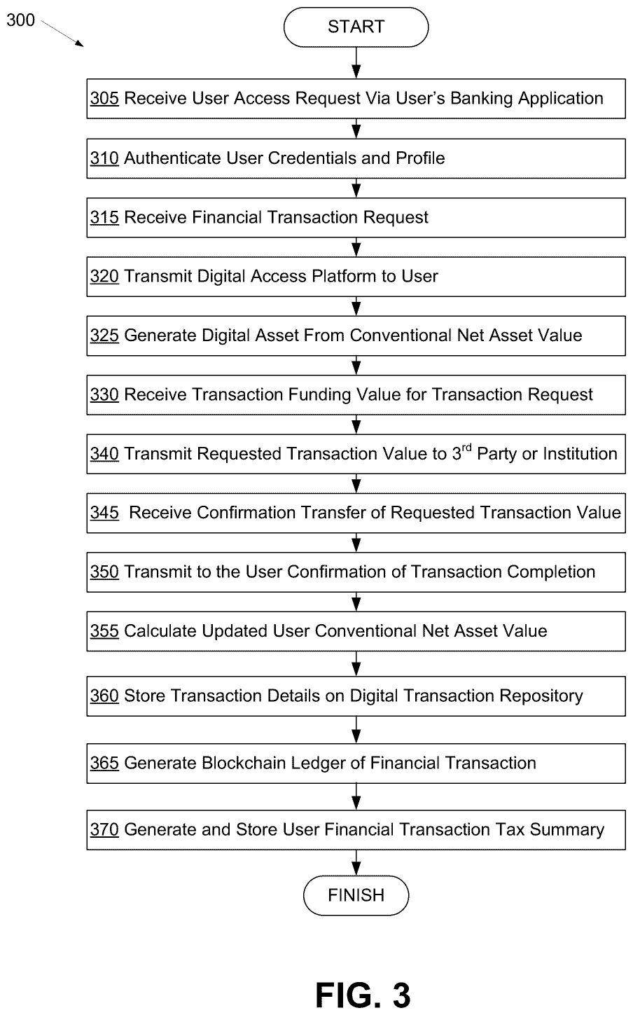

FIG. 3 depicts a flow chart for a financial transaction between two entities in which a user conventional net asset value or net worth may be dynamically calculated and converted to a digital asset for use in the transaction according to one or more aspects of the disclosure. Some or all of the steps of process 300 may be performed using any of the computer machines, server, network, digital asset conversion platform, and/or combinations thereof described herein. In a variety of embodiments, some or all of the steps described below may be combined and/or divided into sub-steps as appropriate.

At step 305, a bank customer, user, or member may use their online banking tool to access a banking transaction module and initiate a financial transaction request. The user request may be submitted via the user's client device, or alternatively, the user's mobile device using the related banking transaction module and/or digital asset module to facilitate the transaction. The user may request access to a personal account and related services previously discussed.

At step 310, the computing machine processor via the network identifies user credentials and profile and verifies and approves access to the user account. As previously discussed, the user account may be established and verified by the member bank or financial institution in compliance with Know Your Customer guidelines.

At step 315, via the online banking tool, the user may transmit a financial transaction action request via the network. The financial transaction request may be one of a credit card transaction, a debit card transaction, a mortgage related transaction, a crypto currency transaction, foreign currency exchange, or other digital clearing house transaction or combinations thereof that may require the conversion of conventional assets to digital assets.

At step 320, access to the digital asset conversion platform may be transmitted to the user via the network and/or the digital asset module. As discussed above, the platform may be configured to facilitate digital transactions such as deposits, withdrawals, savings, credit and debit card purchases and cash withdrawals, remittances, other banking custodial services, insurance related transactions, liquidity pool participation in which traditional deposits are converted to digital assets for yield farming, token trading, etc.

At step 325, the digital asset conversion platform may generate a digital asset for the user. The digital asset may be generated from the user's calculated net asset value (i.e., net worth). As discussed above, the platform may convert a user bank account, savings account, mortgage, investment account, retirement account, etc. into a digital asset for use in the selected financial transaction request. For example, a user may want to purchase an item from a merchant using Bitcoin. The user, via the digital asset conversion platform and/or digital asset module, may choose to select the individual conventional assets to be used in the transaction. For example, the user may include only their checking and savings account funds to calculate a conventional net asset value. Alternatively, the user may choose to select every asset, to include other digital assets, maintained by the financial institution to generate a net asset value. As noted above, the bank may maintain and possess the user's Bitcoin wallet or other cryptocurrency related wallet. In some examples, a user's cryptocurrency address may be integrated/linked or identified with a user's existing bank account to streamline the conversion of conventional assets to digital assets for use in financial transactions. Using the selected conventional assets, the platform may then generate a digital asset required for the transaction. In the present example, the platform may convert the checking and saving account funds into a digital asset, in this example, Bitcoin, for use in the transaction. Again, calculation of the net asset value and generation of the required digital asset occurs at near real-time in the background that may be transparent to the user.

At step 330, the platform may receive the requested transaction funding value (i.e., required amount) required by the merchant, third party, or institution as transmitted by the user via the banking transaction module 230 and/or digital asset module 240, and compared to the generated digital asset. The requested transaction value may be denominated in a local currency, digital cryptocurrency, or other digital asset, or combinations thereof.

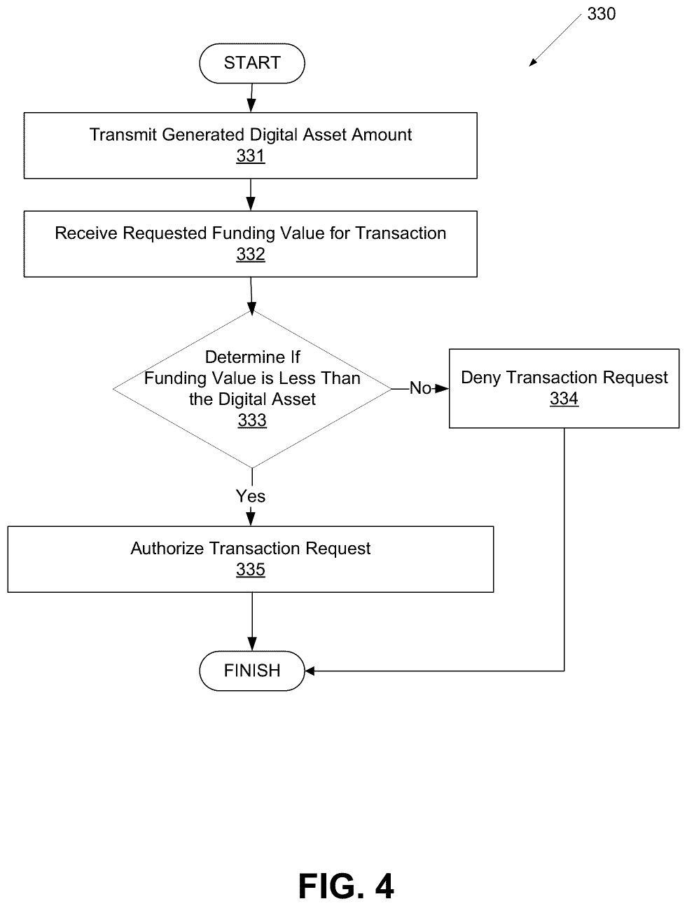

FIG. 4 depicts additional sub-steps of step 330 from FIG. 3. Some or all of the sub-steps of process 330 shown in FIG. 4 may be performed using any of the computer machines, server, network, digital asset conversion platform, and/or combinations thereof described herein. In a variety of embodiments, some or all of the steps described below may be combined and/or divided into sub-steps as appropriate. At step 331, the generated digital asset amount or value may be transmitted to the user. Again, the digital asset may be generated from the user's calculated net asset value and transmitted to the user at step 331.

At step 332, the requested funding value for the transaction may be received from the user.

At step 333, the digital asset conversion platform and/or the digital asset module may determine if the required funding value is less than the generated digital asset value or amount.

At step 334, the transaction request may be denied if the required funding value is more than the generated digital asset. The user would subsequently be required to select additional conventional assets to convert to the required digital asset amount if they desired to move forward with the transaction.

At step 335, the transaction request may be authorized if the required funding value is less than the generated digital asset amount.

Turning back to FIG. 3, at step 340 the required transaction value may be transmitted, as a digital asset to the third party or institution. As noted above, the requested transaction value may be denominated in a local currency, digital cryptocurrency, or other digital asset, or combinations thereof.

At step 345, confirmation of the digital asset transfer and receipt is confirmed with the third party or institution.

At step 350, confirmation of the digital asset transfer may be transmitted to the user along with the related transaction data and confirmation of the receipt of the digital funds by the third part or institution.

At step 355, an updated user conventional net asset value may be calculated minus the transfer of digital assets. Alternatively, an updated digital asset may be calculated and generated if only a portion of the original digital asset was used to complete the requested transaction. In another example, the remaining amount of digital asset may be converted back to the conventional assets in whole or in part, or as designated by the user.

At step 360, a record of the transaction details may be stored via a digital transaction repository.

At step 365, a blockchain ledger of the financial transaction may be generated and stored.

At step 370, a user financial transaction tax summary may be generated as previously discussed. In some examples, the tax summary may be stored via a digital transaction repository. Alternatively, a blockchain ledger of the tax summary may be generated and stored.

A blockchain as described herein is a distributed database that maintains a list of data records, such as real-time asset availability associated with the user, the security of which is enhanced by the distributed nature of the blockchain. A blockchain typically includes several nodes, which may be one or more systems, machines, computers, databases, data stores or the like operably connected with one another. In some cases, each of the nodes or multiple nodes are maintained by different entities. A blockchain typically works without a central repository or single administrator. For example, one well-known application of a blockchain is the ledger of transactions for cryptocurrencies such as Bitcoin. The data records recorded in the blockchain are enforced cryptographically and stored on the nodes of the blockchain.

“Blockchain” as used herein refers to the decentralized electronic ledger of data records which are authenticated by a federated consensus protocol. Multiple computer systems within the blockchain, referred to herein as “nodes” or “compute nodes,” may each comprise a copy of the entire ledger of records. Nodes may write a data “block” to the blockchain, the block comprising data regarding a particular financial transaction. In other embodiments, all nodes have the ability to write to the blockchain. In some embodiments, the block may further comprise a time stamp and a pointer to the previous block in the chain. In some embodiments, the block may further comprise metadata indicating the node that was the originator of the transaction. In this way, the entire record of financial transactions is not dependent on a single database which may serve as a single point of failure and the blockchain will persist so long as the nodes on the blockchain persist. A “private blockchain” is a blockchain in which only authorized nodes may access the blockchain. In some embodiments, nodes must be authorized to write to the blockchain. In other embodiments, nodes must also be authorized to read from the blockchain.

In some examples, as discussed above, a private blockchain infrastructure with a distributed or centralized ledger system may be utilized for storing a record of each transaction and/or storing the tax summary information in a blockchain style format. As described above, the blocks may store data packets of information pertaining to the processing of that particular transaction and are chained together to form a time stamped historic record of the processed transaction and may include the related tax data, or as a separate blockchain. In other examples, a blockchain may be utilized to store a record of the digital assets generated by the digital asset conversion platform as a means to provide an efficient and secure record-keeping function.

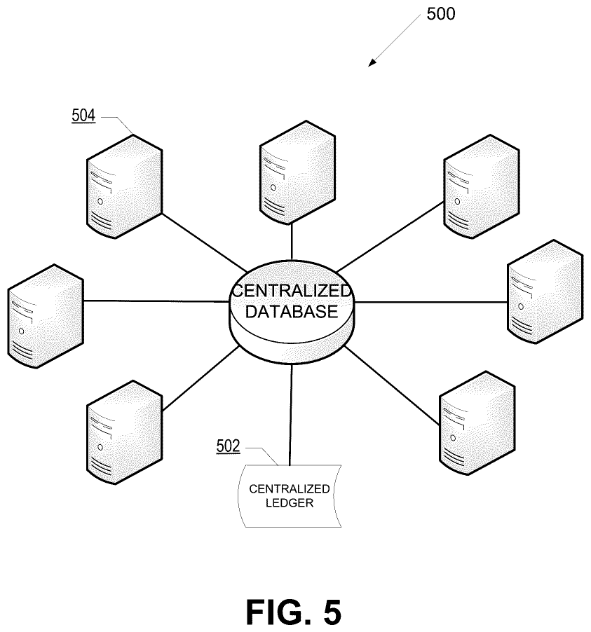

FIG. 5 illustrates a centralized blockchain database architecture environment 500. The centralized database architecture comprises multiple nodes 504 from one or more sources and converge into a centralized database. The system, in this embodiment, may generate a single centralized ledger 502 for data received from the various nodes.

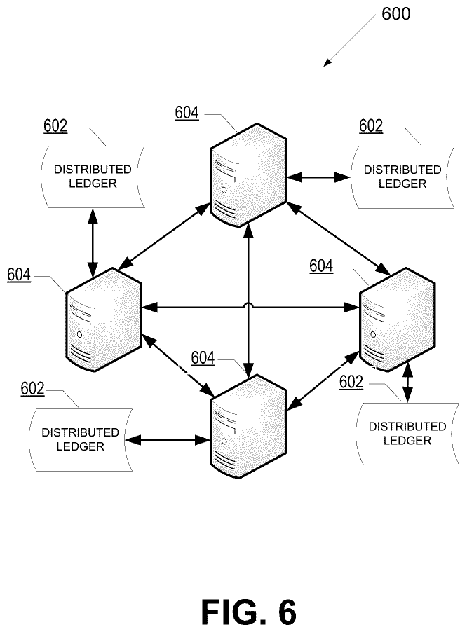

FIG. 6 provides a general blockchain system environment architecture 600. Rather than utilizing a centralized database as discussed above in FIG. 5, a decentralized blockchain configuration or architecture as shown in FIG. 6 may include nodes 604 and copies of the distributed ledger 602.

In some embodiments, a copy of private blockchain may be stored on the digital asset repository. In other embodiments, the storage medium may be a hard drive or flash drive within the computing environment.

One or more aspects discussed herein may be embodied in computer-usable or readable data and/or computer-executable instructions, such as in one or more program modules or platforms, executed by one or more computers or other devices as described herein. Generally, program modules or platforms include routines, programs, objects, components, data structures, and the like that perform particular tasks or implement particular abstract data types when executed by a processor in a computer or other device. The modules or platforms may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules or platforms may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a process, a computing device, a system, a method, and/or a computer program product.

Although the present disclosure has been described in certain specific aspects, many additional modifications and variations would be apparent to those skilled in the art. In particular, any of the various processes described above may be performed in alternative sequences and/or in parallel (on different computer machines) in order to achieve similar results in a manner that is more appropriate to the requirements of a specific application. It is therefore to be understood that the present disclosure may be practiced otherwise than specifically described without departing from the scope and spirit of the present disclosure. Thus, embodiments of the present disclosure should be considered in all respects as illustrative and not restrictive. Accordingly, the scope of the disclosure should be determined not by the embodiments illustrated, but by the appended claims and their equivalents.

What is claimed is:

1. A process for dynamically converting a user conventional net asset value to a digital asset for use in a financial transaction, the process implemented on a computer machine with a processor that executes computer-executable instructions stored on a computer-readable medium, the computer machine, a banking transaction tool, and a digital asset conversion platform coupled together over a communication network, the process comprising the steps of:
receiving, via the banking transaction tool over the communication network, a user request for access to the digital asset conversion platform;
authenticating, via the communication network, user credentials;
receiving, via the banking transaction tool, a financial transaction request;
generating, by the digital asset conversion platform, a digital asset, wherein the digital asset is generated from the user conventional net asset value;
receiving, via the communication network, a transaction value for the financial transaction request;
transmitting, via the communication network, the transaction value to a third party, wherein the transaction value comprises at least a portion of the digital asset;
receiving, via the communication network, a confirmation that the third party received the transaction value completing the financial transaction request;
calculating, via the digital asset conversion platform, an updated user conventional net asset value;
storing, via the communication network, a record of the financial transaction;
generating, via the communication network, a blockchain ledger of the financial transaction; and
generating, via the digital asset conversion platform, a transaction tax summary.

2. The process of claim 1, wherein the digital asset comprises Bitcoin.

3. The process of claim 1, wherein the digital asset comprises a cryptocurrency.

4. The process of claim 1, wherein the digital asset is a non-fungible token (NFT).

5. The process of claim 1, wherein the banking transaction tool is accessible via a mobile phone.

6. The process of claim 1, wherein the financial transaction is a credit card transaction, a debit card transaction, a mortgage related transaction, a crypto currency transaction, or other digital clearing house transaction.

7. The process of claim 1, wherein the transaction tax summary is stored in a blockchain.

8. The process of claim 1, wherein the record of the financial transaction and the transaction tax summary are stored on a digital asset transaction database.

9. The process of claim 1, wherein the user net asset value comprises a native fiat currency, a retirement account, real estate, a mortgage, a deed, a commodity, a mutual fund, an equity, a crypto currency, intellectual property, a non-fungible token (NFT), or combinations thereof.

10. The process of claim 1, wherein a liquidity pool comprises the digital asset for use in a banking lending service.

11. A system for dynamically converting a user conventional asset to a digital asset for use in a banking transaction comprising:
a computer machine with a processor;
a digital asset conversion platform;
a banking transaction tool;
a digital asset transaction database;
a communication network communicatively coupled to the computer machine, the digital asset conversion platform, the banking transaction tool, and the digital asset transaction database; and
a memory, wherein the memory is in communication with the computer machine storing instructions that, when executed by the computer machine, cause the system to:
receive, via the banking transaction tool, a financial transaction request;
generate, by the digital asset conversion platform, a digital asset, wherein the digital asset is generated from a user conventional net asset value;
receive, via the communication network, a transaction value for the financial transaction request;
transmit, via the communication network, the transaction value to a third party, wherein the transaction value comprises at least a portion of the digital asset;
receive, via the communication network, a confirmation that the third party received the transaction value completing the financial transaction request;
calculate, via the digital asset conversion platform, an updated user conventional net asset value;
store, via the communication network, a record of the financial transaction on the digital asset transaction database;
generate, via the communication network, a blockchain ledger of the financial transaction; and
generate, via the digital asset conversion platform, a transaction tax summary.

12. The system of claim 11, wherein the digital asset comprises Bitcoin.

13. The system of claim 11, wherein the digital asset comprises a cryptocurrency.

14. The system of claim 11, wherein the digital asset is a non-fungible token (NFT).

15. The system of claim 11, wherein the banking transaction tool is accessible via a mobile phone.

16. The system of claim 11, wherein the transaction tax summary is stored in a blockchain.

17. The system of claim 11, wherein the financial transaction is a credit card transaction, a debit card transaction, a mortgage related transaction, a crypto currency transaction, or other clearing house transaction.

18. The system of claim 11, wherein the user net asset value comprises a native fiat currency, a retirement account, real estate, a mortgage, a deed, a commodity, a mutual fund, an equity, a crypto currency, Bitcoin, intellectual property, a non-fungible token (NFT), or combinations thereof.

19. A non-transitory machine-readable medium storing instructions that, when executed by one or more processors, cause the one or more processors to perform steps comprising:
receiving a user request for access to the digital asset conversion platform;
authenticating user credentials;
receiving a financial transaction request via a banking transaction tool;
generating a digital asset via a digital asset conversion platform, wherein the digital asset is generated using a user conventional net asset value;
receiving a transaction value for the financial transaction request via the banking transaction tool;
transmitting the transaction value to a third party, wherein the transaction value comprises at least a portion of the digital asset;
receiving a confirmation that the third party received the transaction value completing the financial transaction request;
calculating an updated user conventional net asset value via the digital asset conversion platform;
storing a record of the financial transaction;
generating a blockchain ledger of the financial transaction; and
generating a transaction tax summary via the digital asset conversion platform.

20. The non-transitory machine-readable medium of claim 19, wherein the instructions further cause the one or more processors to perform steps comprising storing the transaction tax summary in a blockchain.
